(19) United States
(12) Patent Application Publication
(10) Pub. No.: US 2006/0212501 A1
(43) Pub. Date: Sep. 21, 2006

(54) Sinusoid selection in audio encoding

(76) Inventors: Andreas Johannes Gerrits, Eindhoven (NL); Albertus Cornelis Den Brinker, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,311

(22) PCT Filed: Nov. 19, 2003
(86) PCT No.: PCT/IB03/05320

§ 371 Date: Jun. 15, 2005

(30) Foreign Application Priority Data
Dec. 19, 2002 (EP) 02080496.9

(51) Int. Cl. G06F 17/10

(52) U.S. Cl. 708/300

(57) ABSTRACT

A method of encoding (1) an audio signal (x(t)) by representing (12) at least part of the audio signal by a plurality of sinusoids, the method comprising the steps of performing an analysis on a first segment of said audio signal, selecting candidate sinusoids based on said analysis, determining for at least one of the candidate sinusoids a phase consistency defined by an extent to which a phase of said candidate sinusoid at a certain moment in time can be predicted from a phase of said candidate sinusoid determined at another moment in time, and selecting said candidate sinusoid as a selected sinusoid when its phase consistency is above a predetermined threshold. The selection of sinusoids according to the invention will result in a smaller number of sinusoids to be encoded for a given audio quality, which is advantageous in terms of bit-rate for a given audio quality.

The invention relates to coding of an audio signal, in which sinusoids relevant for reproducing the audio signal are selected and of which parameters are encoded.

In a sinusoidal audio encoder, at least part of an audio signal is represented by a plurality of sinusoids, which sinusoids are usually described by their frequencies, their amplitudes and optionally their phases. In the encoding process, an audio signal is segmented in time segments, which segments are analyzed for their frequency contents. Typically, the segment size that is used in an audio encoder is within a range of 5 and 60 ms. For each segment a number of sinusoids are selected of which the parameters are subsequently coded. In order to minimize the bit rate for a given audio quality, only relevant sinusoids need to be selected and encoded, i.e. only those sinusoids needed to reproduce the encoded audio signal in an acceptable perceptual quality.

R. McAulay and T. Quartieri, “Speech analysis/synthesis based on sinusoidal representation.”, IEEE Transactions on Acoustics, Speech and Signal Processing, 1986, 43:744-754, disclose a method to select sinusoids called peak-picking. The peak-picking method comprises a selection of those frequencies that have a peak in the amplitude spectrum. Another method for selecting sinusoids is an iterative process called matching pursuit as disclosed by the article from R. Heusdens and S. van de Par, “Rate-distortion optimal sinusoidal modeling of audio and speech using psychoacoustical matching pursuits”, Proc. IEEE Int. Conf. Acoust. Speech and signal Proc., Orlando (USA), 2002. Every iteration, the frequency having the highest peak in the amplitude spectrum is selected and is subsequently subtracted from the signal. The residual signal is used in the next iteration. The process is typically stopped when a fixed number of sinusoids are selected.

A problem arising from the peak-picking method is that it is not known beforehand how many sinusoids are estimated since all peaks are selected. Especially when the amplitude spectrum is noisy, too many sinusoids are selected. In contrast to peak-picking, the number of selected sinusoids in matching pursuit is fixed. As a consequence, in order to guarantee that all relevant sinusoids will be selected, this fixed number should be set high. Again, too many sinusoids will be selected. The selection of too many sinusoids results in a high bit rate, since all of these sinusoids have to be encoded. Another disadvantage is the extra expenses in processing time. Perceptual modeling for example is a process used in many audio encoders in order to encode only that part of an audio signal that can be heard by a human ear. This modeling can be an expensive process and as a result, a large number of sinusoids that have to be analyzed is undesired.

An object of the invention is to provide audio encoding that is advantageous in terms of bit-rate for a given audio quality. To this end, the invention provides a method of encoding, an audio encoder and an audio system as defined in the independent claims. Advantageous embodiments are defined in the dependent claims.

A first aspect of the invention provides a sinusoidal encoding method which comprises the steps of performing an analysis on a first segment of the audio signal, selecting candidate sinusoids based on said analysis, determining for at least one of the candidate sinusoids a phase consistency defined by an extent to which a phase of said candidate sinusoid at a certain moment in time can be predicted from a phase of said candidate sinusoid determined at another moment in time, and selecting said candidate sinusoid as a selected sinusoid when its phase consistency is above a predetermined threshold. Said analysis for selecting candidate sinusoids will usually be a frequency analysis. Such a frequency analysis is for example used in conventional sinusoid selection techniques such as peak-picking or matching pursuit. The phase of said candidate sinusoid at a certain moment in time can be predicted from the phase of said candidate sinusoid determined at another moment in time, as its frequency and the time difference between the time of prediction and the time of determination are known. The invention is based on the insight that when sinusoids are synthesized in a decoder in order to reproduce an encoded audio signal, the sinusoid's phases will be consistent. By selecting those sinusoids for encoding of which the phases are consistent, a better selection is made. Only selected sinusoids are encoded. As a result, the selection procedure based on phase consistency will result in a smaller number of sinusoids to be encoded for a given audio quality, which is advantageous in terms of bit-rate for a given audio quality.

In an embodiment of the invention, said candidate sinusoid's phase consistency is determined by segmenting a second segment of said audio signal into at least a first and a second part, determining the actual phases of said candidate sinusoid in at least the first and the second part, using the actual phase in the first part to serve as the input for predicting the actual phase in the second part, and determining said candidate sinusoid's phase consistency based on a prediction error between the actual phase and the predicted phase in the second part. Usually, the second segment will be equal to the first segment used in the selection of candidate sinusoids, but this is not necessarily the case. An advantage of this embodiment is that a candidate sinusoid's actual phase can be easily determined by performing a frequency analysis like an FFT procedure, for which analysis a part of the audio signal is needed as an input.

In a further embodiment of the invention, a further selection procedure is applied on the selected sinusoids. This further selection procedure comprises the steps of defining for at least one of the selected sinusoids a local frequency band around said selected sinusoid's frequency, combining amplitudes of frequency components within said local frequency band from which at least one of the selected sinusoids within said local frequency band is excluded and further selecting said selected sinusoid as a further selected sinusoid in dependence on the combination of amplitudes. For the further selection procedure applied on the selected sinusoids, an analysis is performed on a third segment of the audio signal. Usually, the third segment will be equal to the second segment used in the selection of selected sinusoids, but this is not necessarily the case. By combining amplitudes of frequency components within said local frequency band from which at least one of the selected sinusoids within said local frequency band is excluded, a measure is obtained for background frequency components within said selected sinusoid's local frequency band. By using this measure, a better selection is made. Also, the further selection is based on a sinusoid's amplitude, which is independent of its phase. Consequently, the further selection can lead to a further reduction of the number of further selected sinusoids in comparison to the number of selected sinusoids selected by the previous selection procedure. Only further selected sinusoids will have to be encoded. As a result, the further selection procedure will result in a smaller number of sinusoids to be encoded for a given audio quality, which is advantageous in terms of bit-rate for a given audio quality. Because of the independence between the selection procedure based on phase consistency and the further selection procedure based on amplitudes, it is also possible to perform both selection procedures in parallel. Both selection procedures then make a selection out of the candidate sinusoids, after which the results can be combined.

In a still further embodiment of the invention, a bandwidth of said local frequency band around said selected sinusoid's frequency is defined in dependence on said selected sinusoid's frequency. Because of said dependence on said selected sinusoid's frequency, the further selection procedure can be tuned suitably for different frequencies. In an even further embodiment of the invention, said dependence on said selected sinusoid's frequency is based on a human's perception of audio. An example of such a dependence is defined by a Bark bandwidth. A Bark is a unit of perceptual frequency, which is known in the art. Other examples are the Mel scale and the ERB scale, which are also known in the art. By taking the human's perception of audio into account, a better decision is made to further select a selected sinusoid as a further selected sinusoid.

According to a further aspect of the invention, said selected sinusoid is further selected as a further selected sinusoid when its amplitude is significant with regard to said combination of amplitudes, which significance is evaluated by thresholding a difference between said selected sinusoid's amplitude and a weighted mean amplitude of frequency components within said selected sinusoid's local frequency band from which at least one of the selected sinusoids within said local frequency band is excluded. By thresholding said difference, a suitable method is obtained for determining the peakiness of a selected sinusoid.

According to a still further aspect of the invention, said significance of said selected sinusoid's amplitude is evaluated by thresholding a ratio of a difference between said selected sinusoid's amplitude and a weighted mean amplitude of frequency components within said selected sinusoid's local frequency band from which at least one of the selected sinusoids within said local frequency band is excluded, and a weighted deviation of the amplitudes of frequency components within said local frequency band from which at least one of the selected sinusoids within said local frequency band is excluded. For said deviation, a definition of the standard deviation can be used for example. By thresholding said ratio, another suitable method is obtained for determining the peakiness of a selected sinusoid.

The aforementioned and other aspects of the invention will be apparent from and elucidated with reference to the embodiments described hereinafter.

In the drawings:

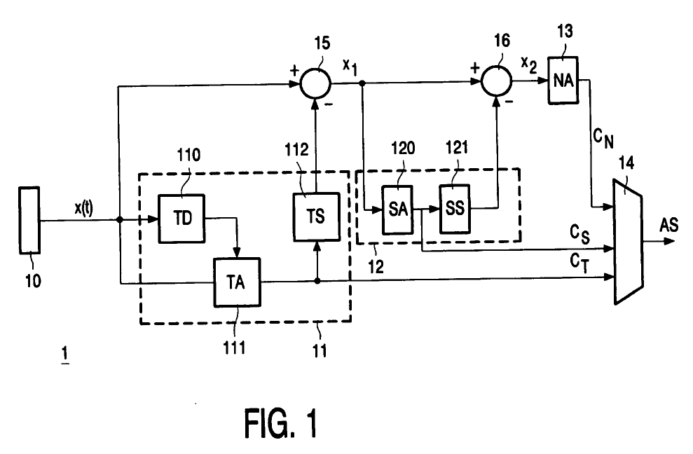

FIG. 1 shows an embodiment of an audio encoder according to the invention;

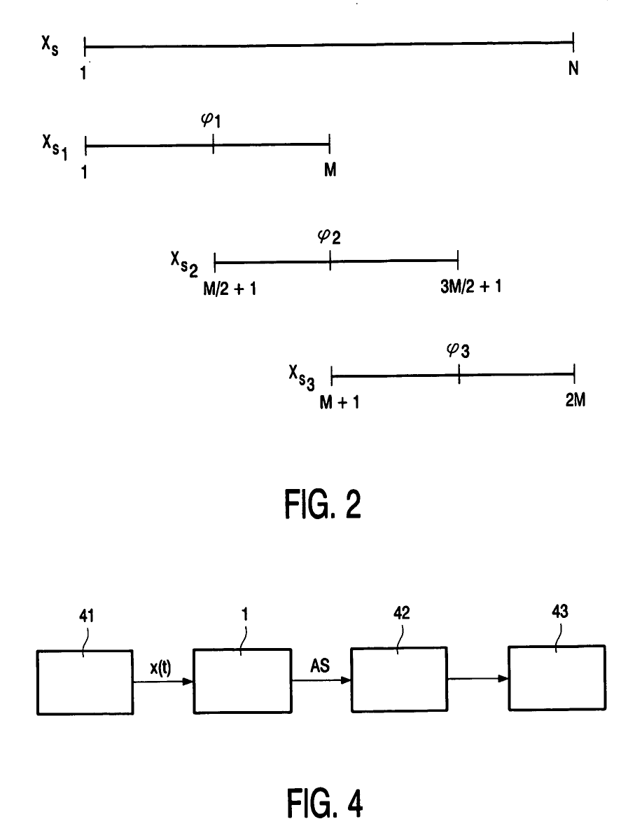

FIG. 2 shows an example of segmenting an audio segment in smaller parts for determining a candidate sinusoid's phase consistency;

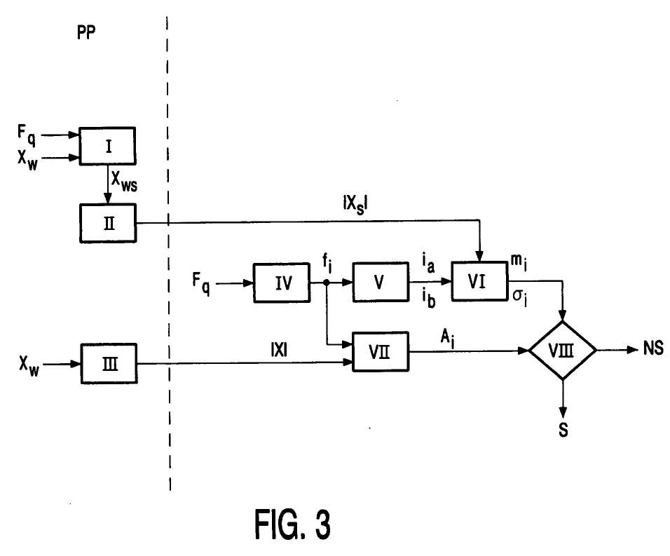

FIG. 3 shows a block diagram representing a further selection procedure applied on selected sinusoids according to the invention;

FIG. 4 shows an embodiment of an audio system according to the invention. The drawings only show those elements that are necessary to understand the invention.

FIG. 1 shows an embodiment of an audio encoder 1 according to the invention, comprising an input unit 10 for obtaining an input audio signal x(t). The audio encoder 1 separates the input signal into three components: transient signal components, sinusoidal signal components and noise signal components. The audio encoder 1 comprises a transient encoder 11, a sinusoidal encoder 12 and a noise analyzer 13.

The transient encoder 11 comprises a transient detector (TD) 110, a transient analyzer (TA) 111 and a transient synthesizer (TS) 112. First, the signal x(t) enters the transient detector 110, the transient analyzer 111 and a subtractor 15. The transient detector 110 estimates if there is a transient signal component and at which position. This information is fed to the transient analyzer 111. This information may also be used in a sinusoidal analyzer (SA) 120 or a noise analyzer (NA) 13 to obtain advantageous signal-induced segmentation. The transient analyzer 111 tries to extract (the main part of) the transient signal component. This is for example done by matching a shape function to a signal segment and determining the content underneath the shape function, e.g. a (small) number of sinusoids. This information is contained in a transient code C_{T}. The transient code C_{T} is furnished to the transient synthesizer 112 and a multiplexer 14. The synthesized transient signal component is subtracted from the input signal x(t) in subtractor 15, resulting in a signal x₁ which is furnished to the sinusoidal analyzer 120 and a further subtractor 16. The sinusoidal analyzer 120 determines the sinusoidal signal components. This information is contained in a sinusoidal code Cs which is furnished to a sinusoidal synthesizer (SS) 121 and the multiplexer 14. From the sinusoidal code C_{S}, the sinusoidal signal components are reconstructed by the sinusoidal synthesizer 121. This signal is subtracted in subtractor 16 from the input signal x₁. The remaining signal x₂ is devoid of (large) transient signal components and (main) sinusoidal signal components and is therefore assumed to mainly consist of noise. Consequently, the signal x₂ is furnished to the noise analyzer 13 where it is analyzed for its spectral and temporal envelope. This information is contained in a noise code C_{N}. In the multiplexer 14, an audio stream AS is constituted which includes the codes C_{T}, C_{S} and C_{N}. The audio stream AS is furnished to e.g. a data bus, an antenna system, a storage medium etc.

In the following, the selection of sinusoids in the sinusoidal analyzer 120 according to an embodiment of the invention will be discussed. It is also possible to use the sinusoid selection procedure in the transient analyzer 111, though this is rarely done in practice as only a small number of sinusoids are analyzed there.

Before the actual selection of sinusoids is performed, first a number of candidate sinusoids are selected. An analysis is performed on a first segment of the audio signal, from which analysis candidate sinusoids are selected. This selection can for example be performed by conventional techniques like peak-picking or matching pursuit which uses a frequency analysis on the first segment. The result will be a number of candidate sinusoids of which the frequencies are stored in F=(f₁, f₂, . . . , f_{L}) with L the number of candidate sinusoids and the frequencies fᵢ defined in Herz (Hz). On at least one of the candidate sinusoids a more specific sinusoid selection procedure will be applied which is based on the phase consistency of the candidate sinusoid. The candidate sinusoid's phase consistency is defined by an extent to which a phase of said candidate sinusoid at a certain moment in time can be predicted from a phase of said candidate sinusoid determined at another moment in time. Next, said candidate sinusoid is selected as a selected sinusoid when said phase consistency is above a predetermined threshold.

In an embodiment of the invention, the candidate sinusoid's phase consistency is determined by first segmenting a second segment of the audio signal into smaller parts. This second segment will usually be equal to the first segment used in the selection of candidate sinusoids, but also a different second segment can be used. Two or more smaller parts have to be available for determining the candidate sinusoid's phase consistency. The smaller parts can possibly overlap each other, but this is not necessarily the case. A second segment xₛ can for example be segmented into three overlapping smaller parts as shown in FIG. 2. If N is the number of samples of the second segment xₛ and N is an even number, the smaller parts are defined by:
xₛ_{₁}[k]=xₛ[k]
xₛ_{₂}[k]=xₛ[k+M/2]
xₛ_{₃}[k]=xₛ[k+M] (1)
in which M=N/2 and 1≦k≦M. The smaller parts xₛ_{₁}, xₛ_{₂}, and xₛ_{₃} each have a length M. On each of these three smaller parts, the actual phases of the candidate sinusoid having a frequency fᵢ from F are determined. For this purpose the smaller parts can be windowed suitable for a frequency analysis, after which the frequency analysis can be performed like an FFT procedure. An example of the positions for a phase determination is shown in FIG. 2 by φ₁, φ₂ and φ₃. Next, the phases can be predicted, in this case from smaller part 1 to 2, from 2 to 3 and from 1 to 3. The differences between the actual and the predicted phases lead to the following prediction errors for the candidate sinusoid:

E_{1,2}=((φ₁−(φ₂−T/2·2π·fᵢ))mod(2π)
E_{2,3}=(φ₃−(φ₂+T/2·2π·fᵢ))mod(2π)
E_{1,3}=(φ₃−((φ₁+T·2π·fᵢ))mod(2π) (2)
in which the prediction errors are in modulo sense (mod(2π)), the phases φ₁, φ₂ and φ₃ are given in radians, T is given in seconds and is defined by T=M/Fₛ in which Fₛ is the sampling frequency (e.g. 44.1 kHz). Using a certain criterion based on these prediction errors E, the candidate sinusoid can be selected as a selected sinusoid. A possible criterion might be a test if at least one of the following conditions is true:
|E_{1,2}|<c
|E_{2,3}|<c
|E_{1,3}|<2·c (3)
in which c is typically dependent on the number of samples N of the second segment xₛ and the number of samples M of the smaller parts xₛ_{₁}, xₛ_{₂} and xₛ_{₃}. An example of a definition for c is:

$$c = \frac{2 \cdot π}{3 \cdot N} \cdot \frac{M}{2} \qquad ( 4 )$$

In a further embodiment of the invention, a further selection of the selected sinusoids is performed. FIG. 3 shows a block diagram representing the further selection process applied on selected sinusoids. The frequencies of these selected sinusoids are stored in F_{q}=(f₁, f₂, . . . , f_{R}) with R the number of selected sinusoids and the frequencies fᵢ defined in Herz (Hz). A third segment can be windowed suitable for a frequency analysis, which results in a windowed segment x_{w}. The third segment will usually be equal to the second segment used in the previous selection of sinusoids, but also a different third segment can be used. First, a preprocessing stage (PP) is performed. In (I), for each frequency fᵢ from F_{q}, the selected sinusoids are synthesized and subtracted from the windowed segment x_{w}. In (II), the resulting segment x_{ws} is zero-padded to length P and analyzed for its frequency components by for example an FFT procedure. The resulting amplitude spectrum is denoted by |X_{S}|. Secondly, in (III), the segment x_{w} is zero-padded to length P and analyzed for its frequency components without subtracting frequencies resulting in amplitude spectrum |X|. After the preprocessing stage, a selection procedure is started for at least one of the selected sinusoids having a frequency fᵢ from F_{q} initialized by (IV). In (V) a local frequency band is determined around said frequency fᵢ. For defining the local frequency band, different definitions can be used. In this case it is chosen to use a Bark bandwidth, e.g. defined by the critical bandwidth:
b(fᵢ)=25+75·(1+1.4·10⁻⁶·fᵢ²)^{0.69} (5)
From the critical bandwidth b(fᵢ) defined in Herz (Hz) the boundary frequencies fₐ and f_{b} are determined by:

$${f}_{a} = max ( {f}_{i} - \frac{b ( {f}_{i} )}{2} , 0 ) \\ {f}_{b} = min ( {f}_{i} + \frac{b ( {f}_{i} )}{2} , \frac{{F}_{s}}{2} ) \qquad ( 6 )$$

The spectrum is indexed with index i_{spect} running from 0 to (P−1) in relation to the frequency f_{spect} according to:

$$\frac{{i}_{spect}}{P} \cdot {F}_{s} = {f}_{spect} \qquad ( 7 )$$

Consequently, the indices iₐ and i_{b} in the spectrum corresponding to the boundary frequencies fₐ and f_{b} are determined by:

$${i}_{a} = round ( \frac{{f}_{a} \cdot P}{{F}_{s}} ) \\ {i}_{b} = round ( \frac{{f}_{b} \cdot P}{{F}_{s}} ) \qquad ( 8 )$$

In which round(r) denotes to rounding of r to the closest integer. Now that the local frequency band is defined, a mean amplitude of the frequency band \overline{m}ᵢ of the selected sinusoid is computed in (VI) from |Xₛ| by:

$${\overline{m}}_{i} = \frac{{\sum }_{k = {i}_{a}}^{{i}_{b}} ( {A}_{s} ( k ) \cdot {W}_{1} ( k ) )}{{\sum }_{k = {i}_{a}}^{{i}_{b}} ( {W}_{1} ( k ) )} \qquad ( 9 )$$

in which A_{S}(k) is the amplitude of the frequency component in the amplitude spectrum |Xₛ| at index k and W₁(k) is a weighting factor dependent on index k. The weighting factor can be constant for all k. However, the weighting factor can for example also be decreasing for an index k closer to one of the boundary frequency indices iₐ or i_{b}, in order to reduce boundary effects. The selected sinusoid will be further selected as a further selected sinusoid in dependence on the other amplitudes within its local frequency band. Therefore, a method for further selecting the selected sinusoid as a further selected sinusoid is to use a criterion based on the weighted mean amplitude of the selected sinusoid's frequency band \overline{m}ᵢ as calculated in (9) and the amplitude of the selected sinusoid Aᵢ=A(i_{f}_{ᵢ}) of which the index i_{f}_{ᵢ}, in the amplitude spectrum can be determined by:

$${i}_{{f}_{i}} = round ( \frac{{f}_{i} \cdot P}{{F}_{s}} ) \qquad ( 10 )$$

In an even further embodiment of the invention, the criterion used in the further selection procedure also comprises a standard deviation σᵢ of the selected sinusoid's local frequency band, which is calculated in (VI) by:

$${σ}_{i} = \sqrt{\frac{{\sum }_{k = {i}_{a}}^{{i}_{b}} ( {( {A}_{s} ( k ) - {\overline{m}}_{i} )}^{2} \cdot {W}_{2} ( k ) )}{{\sum }_{k = {i}_{a}}^{{i}_{b}} ( {W}_{2} ( k ) )}} \qquad ( 11 )$$

In which W₂(k) is a further weighting factor dependent on index k. The further weighting factor can be constant for all k. However, the further weighting factor can for example also be decreasing for an index k closer to one of the boundary frequency indices iₐ or i_{b}, in order to reduce boundary effects. W₂(k) can be chosen equal to W₁(k) used in (9) but this is not necessarily the case. From the amplitude of the selected sinusoid Aᵢ, the mean amplitude \overline{m}ᵢ and the standard deviation ai of the selected sinusoid's frequency band, a ratio rᵢ can be defined that is a measure for a peakiness of the selected sinusoid:

$${r}_{i} = \frac{\vert {A}_{i} - {\overline{m}}_{i} \vert}{{σ}_{i}} \qquad ( 12 )$$

In the selection criterion (VIII) this ratio rᵢ is compared to a threshold Tᵢ. The threshold Tᵢ can for example be a fixed threshold or a threshold dependent on certain parameters like the frequency of the selected sinusoid fᵢ, the index i_{f}_{ᵢ}, of the frequency in the frequency spectrum and/or the number of samples P used for the frequency analysis. An example of a definition for the threshold Tᵢ is:
Tᵢ=(2·i_{f}_{ᵢ})/(P/2)·5+1 (13)
If the ratio rᵢ is above the threshold Tᵢ, the selected sinusoid of frequency fᵢ is kept for encoding (S). Otherwise the selected sinusoid is rejected (NS).

FIG. 4 shows an embodiment of an audio system according to the invention comprising an audio encoder 1 as shown in FIG. 1. Such a system offers recording and/or transmitting features. An audio signal x(t) is obtained by an audio signal obtaining device 41 such as an audio player, a microphone or an audio input connector etc. The audio signal x(t) serves as the input for an audio encoder 1 as shown in FIG. 1. The output audio stream AS is furnished from the audio encoder 1 to a formatting unit 42, which formats the audio stream AS suitably for a communication channel 43 which may be a wireless connection, a data bus or a storage medium. In case the communication channel 43 is a storage medium, the storage medium may be fixed in the system or may also be a removable disc, a memory stick etc. The communication channel 43 may be part of the audio system, but will however often be outside the audio system.

It should be noted that the above-mentioned embodiments illustrate rather than limit the invention, and that those skilled in the art will be able to design many alternative embodiments without departing from the scope of the appended claims. In the claims, any reference signs between parenthesis shall not be construed as limiting the claim. The word ‘compromising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, the invention provides a method of encoding an audio signal by representing at least part of said audio signal by a plurality of sinusoids, the method comprising the steps of performing an analysis on a first segment of said audio signal, selecting candidate sinusoids based on said analysis, determining for at least one of the candidate sinusoids a phase consistency defined by an extent to which a phase of said candidate sinusoid at a certain moment in time can be predicted from a phase of said candidate sinusoid determined at another moment in time, and selecting said candidate sinusoid as a selected sinusoid when its phase consistency is above a predetermined threshold. The selection of sinusoids according to the invention will result in a smaller number of sinusoids to be encoded for a given audio quality, which is advantageous in terms of bit-rate for a given audio quality.

1. A method of encoding an audio signal by representing at least part of said audio signal by a plurality of sinusoids, the method comprising the steps of:
performing an analysis on a first segment of said audio signal;
selecting candidate sinusoids based on said analysis;
determining for at least one of the candidate sinusoids a phase consistency defined by an extent to which a phase of said candidate sinusoid at a certain moment in time can be predicted from a phase of said candidate sinusoid determined at another moment in time; and
selecting said candidate sinusoid as a selected sinusoid when its phase consistency is above a predetermined threshold.

2. A method as claimed in claim 1, wherein the determination of said candidate sinusoid's phase consistency comprises the steps of:
segmenting a second segment of said audio signal into at least a first and a second part;
determining the actual phases of said candidate sinusoid in at least the first and the second part;
using the actual phase in the first part to serve as the input for predicting the actual phase in the second part; and
determining said candidate sinusoid's phase consistency based on a prediction error between the actual phase and the predicted phase in the second part.

3. A method as claimed in claim 1, wherein the method further comprises a further selection out of the selected sinusoids which comprises the steps of:
defining for at least one of the selected sinusoids a local frequency band around said selected sinusoid's frequency;
combining amplitudes of frequency components within said local frequency band from which at least one of the selected sinusoids within said local frequency band is excluded; and
further selecting said selected sinusoid as a further selected sinusoid in dependence on the combination of amplitudes.

4. A method as claimed in claim 3, wherein a bandwidth of said local frequency band around said selected sinusoid's frequency is defined in dependence on said selected sinusoid's frequency.

5. A method as claimed in claim 4, wherein said dependence on said selected sinusoid's frequency is based on a human's perception of audio.

6. A method as claimed in claim 3, wherein said selected sinusoid is further selected as a further selected sinusoid when its amplitude is significant with regard to said combination of amplitudes, which significance is evaluated by thresholding a difference between said selected sinusoid's amplitude and a weighted mean amplitude of frequency components within said selected sinusoid's local frequency band from which at least one of the selected sinusoids within said local frequency band is excluded.

7. A method as claimed in claim 3, wherein said selected sinusoid is further selected as a further selected sinusoid when its amplitude is significant with regard to said combination of amplitudes, which significance is evaluated by thresholding a ratio of:
a difference between said selected sinusoid's amplitude and a weighted mean amplitude of frequency components within said selected sinusoid's local frequency band from which at least one of the selected sinusoids within said local frequency band is excluded; and
a weighted deviation of the amplitudes of frequency components within said local frequency band from which at least one of the selected sinusoids within said local frequency band is excluded.

8. An audio encoder for encoding an audio signal by representing at least part of said audio signal by a plurality of sinusoids, the audio encoder comprising:
means for performing an analysis on a first segment of said audio signal;
means for selecting candidate sinusoids based on said analysis;
means for determining for at least one of the candidate sinusoids a phase consistency defined by an extent to which a phase of said candidate sinusoid at a certain moment in time can be predicted from a phase of said candidate sinusoid determined at another moment in time; and
means for selecting said candidate sinusoid as a selected sinusoid when its phase consistency is above a predetermined threshold.

9. An audio encoder as claimed in claim 8, wherein the audio encoder is further conceived to perform a further selection out of the selected sinusoids for which further selection the audio encoder further comprises:
means for defining for at least one of the selected sinusoids a local frequency band around said selected sinusoid's frequency;
means for combining amplitudes of frequency components within said local frequency band from which at least one of the selected sinusoids within said local frequency band is excluded; and
means for further selecting said selected sinusoid as a further selected sinusoid in dependence on the combination of amplitudes.

10. Audio system comprising means for obtaining an audio signal, an audio encoder as claimed in claim 8 for encoding said audio signal to obtain an encoded audio signal, and a formatting unit for formatting the encoded audio signal into a format suitable for storage and/or transmission.
